(19) United States
(12) Patent Application Publication
(10) Pub. No.: US 2016/0021143 A1
(43) Pub. Date: Jan. 21, 2016

(54) DEVICE FEDERATION

(71) Applicants: DAVID BROWNING, Beaverton, OR (US); KRISTOFFER FLEMING, Chandler, AZ (US); VASUDEV BIBIKAR, Austin, TX (US)

(72) Inventors: DAVID BROWNING, Beaverton, OR (US); KRISTOFFER FLEMING, Chandler, AZ (US); VASUDEV BIBIKAR, Austin, TX (US)

(21) Appl. No.: 14/336,044

(22) Filed: Jul. 21, 2014

(51) Int. Cl. H04L 29/06

(52) U.S. Cl. CPC H04L 63/20

(57) ABSTRACT

The present application is directed to device federation. Interaction between devices in a federation may be conducted using reduced security, while interactions with devices outside the federation may be conducted with a variable security up to a standard level of security that may be associated with a communication protocol. A device may comprise at least a communication module and a federation module. The federation module may include at least a relationship rules module having at least one rule based on relationships between devices and a link security control module to control the amount of security utilized during interaction based on the at least one rule. The link security control module may also control how a device may be inducted into a federation by, if necessary, providing qualification data to qualify the device for induction.

### TECHNICAL FIELD

The present disclosure relates to device interaction, and more particularly, to a system wherein devices may be part of a federation in which communication security may be reduced.

### BACKGROUND

The evolution of communication technology has caused a variety of new types of devices to become available to the modern consumer. Existing simple wireless handsets allowing a user to conduct voice interaction are being joined by devices that allow for both voice communication and data-based interactions. For example, smartphones, tablet computers, etc. may be capable of loading and executing a variety of applications that may employ communication resources in the devices to transmit and receive data. These applications may provide functionality related to, for example, user-to-user interaction (e.g., email, messaging, social media, networking platforms for professionals, etc.), time/resource planning, online commerce, financial transaction management, professional aids (e.g., conferencing, collaborative workspaces, etc.), entertainment (e.g., games, multimedia access, etc.), etc. Joining these prevalent mobile platforms are emerging “wearable” devices that may range from simple interfaces to proximate mobile devices that may be worn in a manner so as to be readily available for actuation to full-blown standalone computing platforms.

As new devices are released, what is becoming apparent is that newer technologies do not serve as a one-for-one replacement for existing devices. For example, a user does not stop using a tablet computer because a new smartphone is purchased, the smart phone is not be replaced by a new wearable, etc. Instead, the user may accumulate a group of devices that may commonly be used together. For example, the tablet computer may exchange data with the smart phone and/or the wearable, the wearable may exchange data with the smart phone (e.g., to serve as an interface to the smart phone when the user is engaged in activity), etc. At least one issue that may exist in these interactions is that these devices that are commonly used together may be hindered through the limitations presented by standardized communication. For example, standard communication protocols include safeguards to protect known devices (e.g., any of the devices discussed above) when interacting with unknown devices that present a potentially hazardous situation due to, for example, the presence of malicious software (malware), vulnerability to attacks by hackers, etc. These safeguards (e.g., encryption) may ensure that a user's device, data, etc. are protected, but may also negatively impact the overall performance of the devices due to the overhead imposed by the security provisions. In situations where the devices are known to be safe and the potential danger is minimal, such safety provisions may be overkill and only serve to reduce performance.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates example interactions involving federation of devices in accordance with at least one embodiment of the present disclosure;

FIG. 2 illustrates an example configuration for a device usable in accordance with at least one embodiment of the present disclosure;

FIG. 3 illustrates example operations by which a device may be inducted into a federation in accordance with at least one embodiment of the present disclosure;

FIG. 4 illustrates an example open systems interconnect (OSI) in accordance with at least one embodiment of the present disclosure;

FIG. 5 illustrates example operations for induction into a federation in accordance with at least one embodiment of the present disclosure; and

FIG. 6 illustrates example operations for operating in a federation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present application is directed to device federation. In one embodiment, devices may be in members of a federation. Interaction within the federation may be conducted using reduced security, while interactions with devices outside the federation may be conducted with a variable security (e.g., depending on the relationship of the devices) up to a standard level of security that may be associated with a communication protocol. An example device may comprise at least a communication module and a federation module. The federation module may comprise at least a relationship rules module and a link security control module. The relationship rules module may comprise at least one rule based on the relationship of the devices, while the link security control module may control the amount of security used during interaction based on the at least one rule. For example, if a device in a federation is going to interact with another device in the federation, then the two devices may interact utilizing only a minimal amount of encryption. The reduced level of encryption may reduce processing and/or communication overhead and increase speed. Devices that are going to interact with devices in another familiar federation or a device that is not in a federation may operate using additional security (e.g., additional levels of encryption). In one embodiment, the link security control module may also control how a device is inducted into a federation by, if necessary, providing qualification data to qualify the device for induction.

In at least one embodiment, a device to operate in a federation of devices may comprise, for example, at least a communication module and a federation module. The communication module may be to support interaction with other devices. The federation module may be to identify at least one other device with which interaction is to take place via the communication module, determine a relationship between the device and at least one other device and configure an amount of security to be employed in the interaction with the at least one other device based on the relationship.

For example, the federation module being to identify the at least one other device may comprise the federation module being to cause the communication module to transmit a message to the at least one other device, the message requesting at least one of user identification data, device identification data or a federation identification data. The federation module being to determine a relationship may comprise the federation module being to determine if the at least one other device is in a federation with the device, is in another federation familiar to the device or is not in a federation.

In at least one embodiment, the federation module may comprise at least a relationship rules module and a link security control module. The relationship module may comprise at least one rule to control the amount of security employed in the interaction with the at least one other device based at least on the relationship. At least one rule controlling when the other device is in a federation with the device, or in another federation familiar to the device, may be to cause the device to interact with the at least one other device with reduced security. The device being to interact with the at least one other device with reduced security may comprise, for example, the device being to engage in communication with the at least one other device utilizing a standard communication protocol with at least one level of encryption that would typically exist in the standard communication protocol being removed. At least one rule controlling when the at least one other device is not federated may be to cause the device to interact with the at least one other device utilizing the standard communication protocol. The link security control module may be to configure the amount of security to be employed in the interaction based at least on the at least one rule.

In at least one embodiment, the link security control module may further be to control induction of the device into a federation. The link security control module being to control induction of the device into a federation may comprise, for example, the link security control module being to present qualification data to qualify the device for being inducted into the federation. An example method for operating in a federation of devices may comprise identifying, in a device, at least one other device with which interaction is to take place, determining a relationship between the device and the at least one other device and configuring an amount of security to be employed in the interaction with the at least one other device based on the relationship.

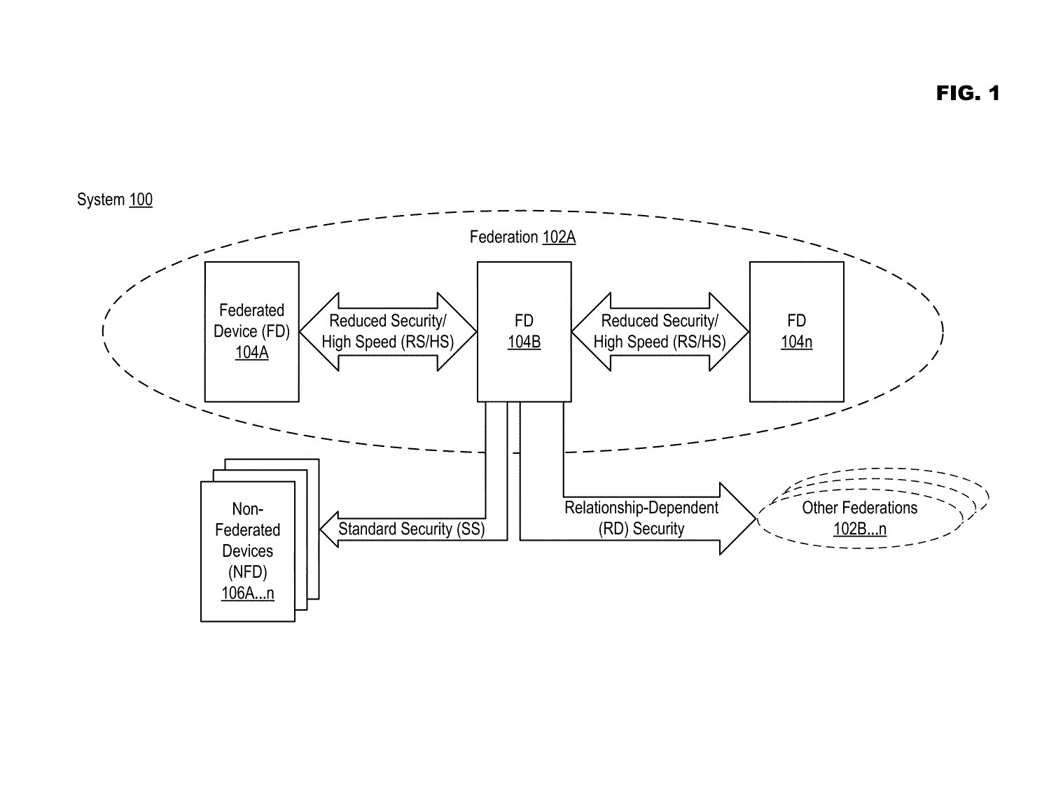

FIG. 1 illustrates example interactions involving federation of devices in accordance with at least one embodiment of the present disclosure. System 100 may comprise federated devices (FD) 104A, 104B . . . 104n (collectively, “FDs 104A . . . n”) inducted into federation 102A, devices inducted into other federations 102B . . . n, non-federated devices (NFDs) 106A . . . n, etc. Various examples of these devices may comprise, but are not limited to, mobile communication devices such as a cellular handset, smart phone, etc. based on the Android® operating system (OS) from the Google Corporation, iOS® from the Apple Corporation, Windows® OS from the Microsoft Corporation, Mac OS from the Apple Corporation, Tizen™ OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., mobile computing devices such as a tablet computer like an iPad® from the Apple Corporation, Surface® from the Microsoft Corporation, Galaxy Tab® from the Samsung Corporation, Kindle Fire® from the Amazon Corporation, etc., an Ultrabook® including a low-power chipset manufactured by Intel Corporation, netbooks, notebooks, laptops, palmtops, etc., wearable devices such as wristwatch form factor computing devices like the Galaxy Gear® from Samsung, eyewear form factor interfaces like Google Glass® from the Google Corporation, etc., typically stationary computing devices such as a desktop computer, a server, a smart television, small form factor computing solutions (e.g., for space-limited computing applications, TV set-top boxes, etc.) like the Next Unit of Computing (NUC) platform from the Intel Corporation, etc.

In general, federations may define groups of devices associated with a particular user, a particular use, etc. For example, a user's personal devices (e.g., smart phone, tablet computer, wearable devices, etc.) may be inducted into a federation. Alternatively, all of the devices that may be used to perform a certain task (e.g., sales floor representative, customer service person, stockperson, etc.) may be inducted into a federation. Devices may be part of more than one federation (e.g., a user's smart phone may be part of a federation of personal federation and a federation related to the user's profession). Induction into a federation may result a change to the configuration of a device that allows it to be identified as being federated. For example, federation identification data, a list of device IDs for devices in a federation, user identification data, etc. may be stored on a device. Devices in a federation may be known to each other, and thus, may be trusted. This trust may allow federated devices to interact using reduced security.

FDs 104A . . . n may all be part of federation 102A. Due to their membership in federation 102A, FDs 104A . . . n may interact using reduced security/high speed (RS/HS) communication as illustrated in FIG. 1. When considering standard short-range wireless communication protocols such as, for example, Bluetooth, wireless local area networking (WLAN), etc., RS/HS interaction may still employ these standard communication protocols but with fewer security measures. For example, the amount of encryption used to protect the contents of wireless transmissions may be reduced. The reduction in security measures results in less processing/communication overhead, which may manifest in, for example, an overall increase in communication speed, reduced power consumption during communication, and more generally, an improved quality of experience.

Interactions between FDs 104A . . . n and other devices that have not been inducted into federation 102A based upon relationship. For example, interactions between FDs 104A . . . n and other federation 102B . . . n may be based on relationship dependent (RD) security. For example, if other federation 102B is known to federation 102A (e.g., in a married couple, federation 102A corresponds to one of the married couple and federation 102B corresponds to the other of the married couple), then communication may operate at the lowest security level RS/HS. If the relationship is more distant (e.g., federations corresponding to more remote relatives, federations corresponding to friends, federations corresponding to business colleagues, etc.), then a higher level of security (e.g., additional layers of encryption) may be used. IF FDs 104B are interacting with NFDs 106A . . . n, then the security that is customarily used in accordance with a standard communication protocol may be employed (e.g., devices may communicate as they do today).

In one embodiment, communications targeted at devices outside of federation 102A (e.g., in other federations 102B . . . n or NFDs 106A . . . n) may be configured to utilize at least one of FDs 104A . . . n as a proxy device. For example, when FD 104A is to interact with NFD 106A, FD 104A may transmit data to be forwarded to NFD 106A to FD 104B via RS/HS communication. FD 104B may then forward the data to NFD 106A utilizing security settings customarily existing in a standard communication protocol. Likewise, information inbound to FD 104A from NFD 106A may be received by FD 104B via standard communication and forwarded to FD 104A via RS/HS communication. In the same or a different embodiment, the relationship between devices may govern not only how data is transmitted, but also what data is transmitted. For example, a user of FD 104A (e.g., a smart phone) may be able to indicate that certain data is distributable only within federation 102A, only with a recognized federation, etc. Examples of data that may be distributed only within federation 102A may include, but is not limited to, social security data, residential address data, medical data, account number data, personal contact numbers/addresses, etc. The certain data may be indicated by manually marking the data through an application/user interface in FD 104A, based on a category such as a data type (e.g., file extension), associated applications, etc. FD 104A may first verify that the destination device is within federation 102A (e.g., or within a recognized federation) before transmitting messages including the certain data.

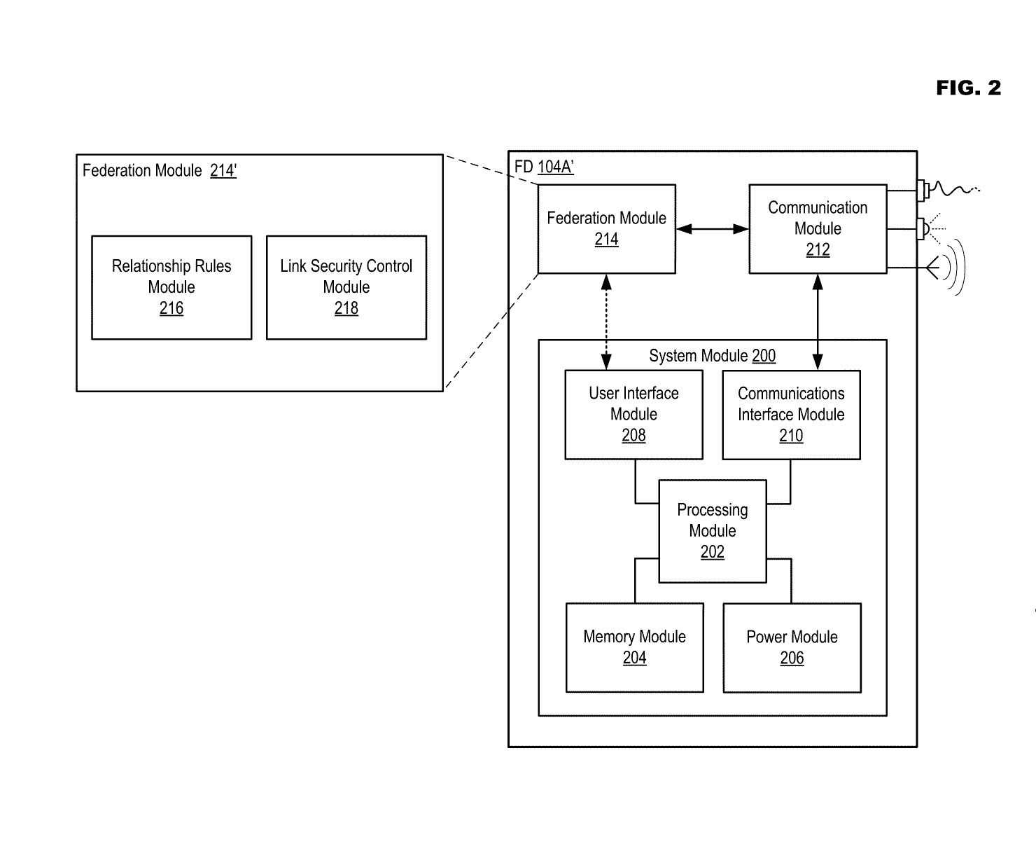

FIG. 2 illustrates an example configuration for a device usable in accordance with at least one embodiment of the present disclosure. In particular, example FD 104A′ may be capable of performing any of the activities disclosed in FIG. 1. However, FD 104A′ is meant only as an example of an apparatus usable in embodiments consistent with the present disclosure, and is not meant to limit these various embodiments to any particular manner of implementation. It is also important to note that while example FD 104A′has been illustrated in FIG. 2 for the sake of explanation herein, any of the other devices also illustrated in FIG. 1 (e.g., FDs 104B . . . n, NFDs 106A . . . n, etc.) may also be configured in a manner similar to example FD 104A′.

FD 104A′ may comprise, for example, system module 200 configured to manage device operations. System module 200 may include, for example, processing module 202, memory module 204, power module 206, user interface module 208 and communication interface module 210. FD 104A′ may further include communication module 212 and federation module 214. While communication module 212 and federation module 214 have been shown as separate from system module 200, the example implementation illustrated in FIG. 2 has been provided merely for the sake of explanation. Some or all of the functionality associated with communication module 210 and federation module 214 may also be incorporated into system module 200.

In FD 104A′, processing module 202 may comprise one or more processors situated in separate components, or alternatively, one or more processing cores embodied in a single component (e.g., in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in FD 104A′. Some or all of the functionality commonly associated with the support circuitry may also be included in the same physical package as the processor (e.g., such as in the Sandy Bridge family of processors available from the Intel Corporation).

Processing module 202 may be configured to execute various instructions in FD 104A′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) and/or read-only memory (ROM) in a fixed or removable format. RAM may include volatile memory configured to hold information during the operation of FD 104A′ such as, for example, static RAM (SRAM) or Dynamic RAM (DRAM). ROM may include non-volatile (NV) memory modules configured based on BIOS, UEFI, etc. to provide instructions when FD 104A′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power module 206 may include internal power sources (e.g., a battery, fuel cell, etc.) and/or external power sources (e.g., electromechanical or solar generator, power grid, fuel cell, etc.), and related circuitry configured to supply FD 104A′ with the power needed to operate. User interface module 208 may include hardware and/or software to allow users to interact with FD 104A′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, etc.) and various output mechanisms (e.g., speakers, displays, lighted/flashing indicators, electromechanical components for vibration, motion, etc.). The hardware in user interface module 208 may be incorporated within FD 104A′ and/or may be coupled to FD 104A′ via a wired or wireless communication medium.

Communication interface module 210 may be configured to manage packet routing and other control functions for communication module 212, which may include resources configured to support wired and/or wireless communications. In some instances, FD 104A′ may comprise more than one communication module 212 (e.g., including separate physical interface modules for wired protocols and/or wireless radios) all managed by a centralized communication interface module 210. Wired communications may include serial and parallel wired mediums such as, for example, Ethernet, USB, Firewire, Digital Video Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), etc.), short-range wireless mediums (e.g., Bluetooth, WLAN, Wi-Fi, etc.), long range wireless mediums (e.g., cellular wide-area radio communication technology, satellite-based communications, etc.) or electronic communications via sound waves. In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission. While the embodiment disclosed in FIG. 2 illustrates communication interface module 210 being separate from communication module 212, it may also be possible for the functionality of communication interface module 210 and communication module 212 to be incorporated into the same module.

Consistent with the present disclosure, federation module 214 may interact with at least communication module 2, and in some embodiments, also with user interface module 208. For example, federation module 214 may cause communication module 212 to transmit and receive data. Data interaction within federation 102A may typically occur via wired and/or short-range wireless communication (e.g., any form of short-range communication so as to limit exposure to devices outside federation 102A). Data may be sent from, or received into, federation 102A via any form of wired or wireless communication. User interface module 208 may be utilized in the operations of federation module 214 for configuration, induction into a new federation, etc. For example, a user may employ user interface module 208 when configuring security measures for communicating inside and outside of federation 102A, for setting data protections to limit what type of data can be sent inside and outside of federation 102A, for inputting qualification data during an induction process in which FD 104A′ is inducted into a new federation, etc.

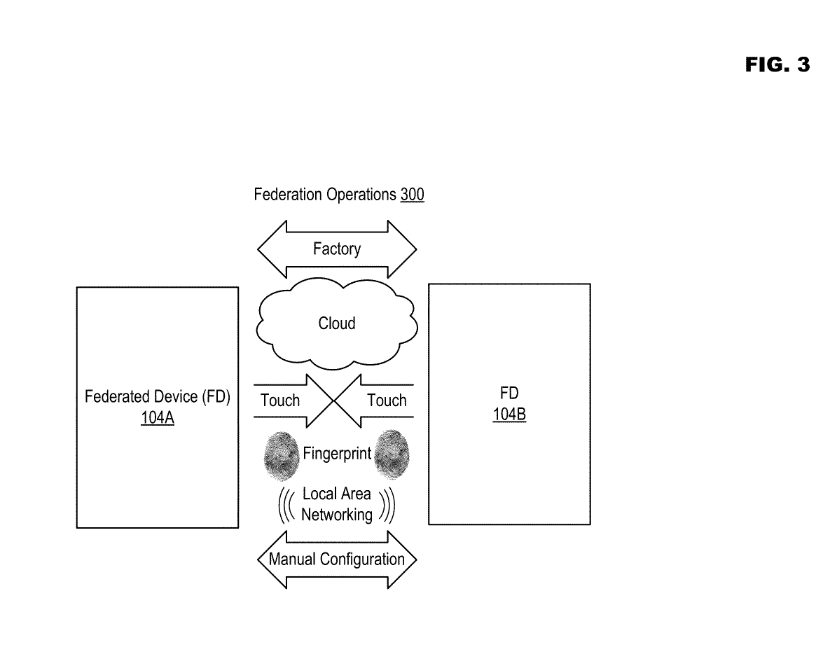

FIG. 2 further illustrates an embodiment of federation module 214. Federation module 214′ may comprise, for example, at least relationship rules module 216 and link security control module 218. In general, relationship rule module 216 may comprise at least one rule that may be utilized by link security control module 218 for controlling the amount of security employed in intra-federation, inter-federation and extra-federation communication. For example, relationship rules module 216 may include at least one rule setting forth that intra-federation communication requires only link layer encryption. Thus, link security control module may cause FD 104A′ to communicate utilizing only link layer encryption when transmitting data inside of federation 102A. Rules may also exist controlling the amount of security to employ when interacting with devices in other federations 102B . . . n familiar to federation what data can be transmitted within federation 102A, to NFDs 106A . . . n not within a federation, what data is allowed to be shared within federation 102A, etc. Link security control module 218 may also participate in activities related to the induction of FD 104A′ into new federations, which will be discussed in FIG. 3.

FIG. 3 illustrates example operations by which a device may be inducted into a federation in accordance with at least one embodiment of the present disclosure. In general, the formation of federations 102A . . . n may occur via a variety of operations 300 that allow a device to become recognized as inducted into a federation (e.g., an FD 104A . . . n). For example, a device may be inducted in a federation through an operation that occurs at the factory that manufactures the device. When a device is produced, it may be encoded with certain information that associates it with a certain federation 102A . . . n. Indicia of the federation may be provided on the packaging of the device so that a consumer may purchase devices already inducted into a certain federation 102A . . . n. Devices may also be inducted into a federation through cloud-based (e.g., at least one remote computing device accessible via a network) operations. For example, upon activation of a device, an application on the device, a sensor in the device (e.g., a sensor capable of detecting other devices within proximity of the device), etc., information may be sent to the cloud-based solution to induct the device into at least one certain federation 102A . . . n. The selection of the at least one certain federation 102A . . . n may be set up beforehand by a user (e.g., on a device with an Internet connection), may be set up on-the-fly by the user, etc. The cloud-based solution may then cause the device to become an FD 104A . . . n identified with a federation 102A . . . n by, for example, recording device data within the cloud-based solution, by providing some data back to the device identifying the device as an FD 104A . . . n inducted into a federation 102A . . . n, etc.

Other example operations by which devices may be inducted into one or more federations 102A . . . n may include, for example, “touching” the devices, using user biometric information as qualification data, interaction via local area network, manual configuration, etc. Touching may include holding devices in close-proximity so that data may be shared by wireless interaction over a short distance. The data being communicated may include, for example, identification data corresponding to a federation 102A . . . n into which devices may be inducted, a device identification that may be inserted into a listing within each device that records members of a particular federation 102A . . . n, etc. Alternatively, biometric data such as fingerprint data may be digitized into a format that may identify devices as FDs 104A . . . n that have been inducted a certain federation 102A . . . n (e.g., all inducted devices will contain the fingerprint-based data for verification purposes). Typical networking information (e.g., device address, MAC address, public key data, etc.) generated as a result of, for example, a Bluetooth pairing used to form a Piconet may also be used to identify devices as FDs 104A . . . n that have been inducted in a certain federation 102A . . . n. It may also be possible for a user to utilize personal information as a key for use by devices that a user desires to have inducted into a certain federation 102A . . . n. For example, a user may manually enter a username and/or password to login to several different devices, the entry of the username and/or password causing each of the different devices to then be logged into a cloud-based service. The cloud-based service may proceed to grant access to an account associated with the user and/or password that also causes each of the different devices to be inducted into at least one federation 102A . . . n. In another embodiment, upon attempted entry by a device into at least one federation 102A . . . n (e.g., by attempting to access a FD 104A . . . n already in a certain federation 102A . . . n, by executing an application that may control federation admission, etc.), a user may be prompted to provide personal information (e.g., birthday, answer a challenge question, etc.) to qualify the device for induction into a federation 102A . . . n. In the same or another embodiment, it may also be possible for a list of FDs 104A . . . n to be maintained on at least one FD 104A . . . n configured to act as a federation manager for a federation 102A . . . n.

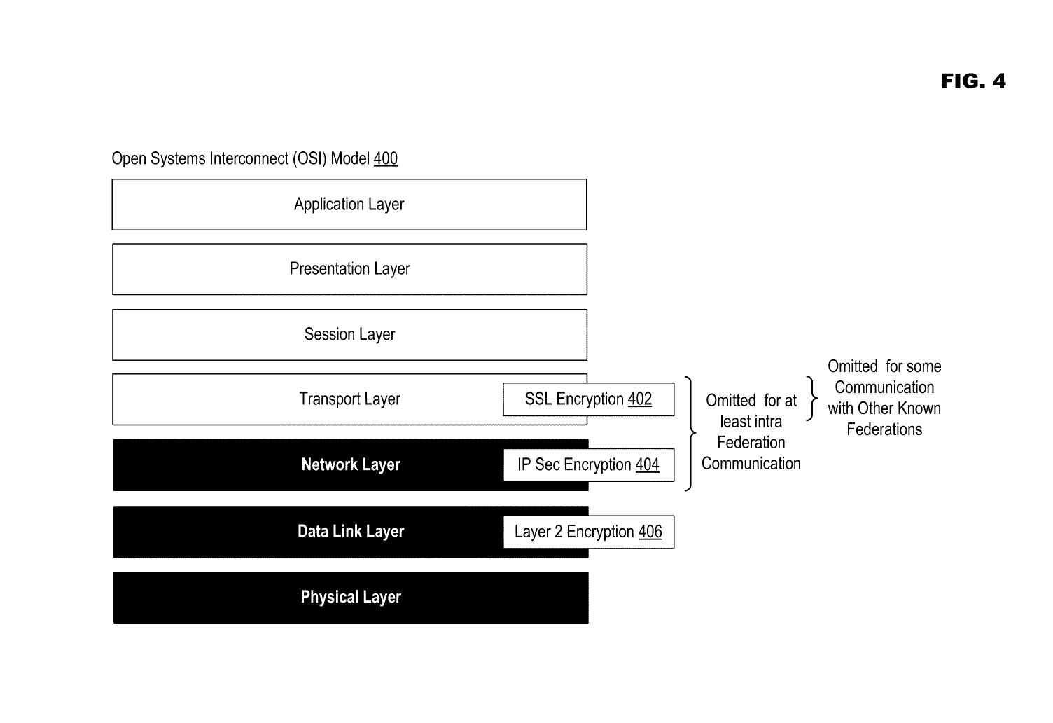

FIG. 4 illustrates an example open systems interconnect (OSI) in accordance with at least one embodiment of the present disclosure. OSI model 400 may conceptualize internal functions of a communication system by partitioning it into abstraction layers. The model is a product of the Open Systems Interconnection project at the International Organization for Standardization (ISO), maintained by the identification ISO/IEC 7498-1. OSI model 400 is employed herein as an example to explain how security may be implemented for different modes of interaction (e.g., intra-federation, inter-federation and extra-federation) consistent with the present disclosure.

In the disclosed example, at least three layers in PSI model 400 may comprise some form of encryption. The transport layer may comprise secure sockets layer (SSL) encryption 402, the network layer may comprise Internet protocol security (IP Sec) encryption 404 and the data link layer may comprise Layer 2 encryption 406. While specific encryption protocols are referenced herein, it is important to note that other forms of encryption may be available at various layers in OS model 400, the particular types of encryption illustrated in FIG. 4 being selected only for the sake of explanation herein. For extra-federation communication (e.g., including interaction with FDs 104A . . . n in an unfamiliar other federation 102B . . . n, NFDs 106A . . . n, etc.), all three types of encryption 402 to 406 may be employed. The use of all three types of encryption may be consistent with what is understood to be “standard” communication today in that encryption types 402 to 406 are usually employed in wireless communication between any two devices. While the use of all three types of encryption 402 to 406 may help to ensure that the interaction remains secure, it may prove to be “overkill” when the interaction involves only known devices.

Inter-federation interaction occurring between devices 104A . . . n and other federations 102B . . . n may employ Layer 2 encryption 406 and possibly IP Sec encryption 404 depending upon the relationship. As discussed above, some inter-federation relationships (e.g., married couple) may be closer than others (e.g., friends, work colleagues, etc.), and thus, the level of encryption required may be variable. For example, the types of encryption 402 to 406 may be configured on a federation-to-federation basis, a category basis (e.g., close relation to distant relation), etc. For intra-federation communication (e.g., between devices 104A . . . n in federation 102A), only Layer 2 encryption 404 may be required (e.g., encryption types 402 and 404 may be removed). This may allow the interaction to still have some level of security while substantially reduce processing/communication overhead, and thus, improving speed, quality of service, etc.

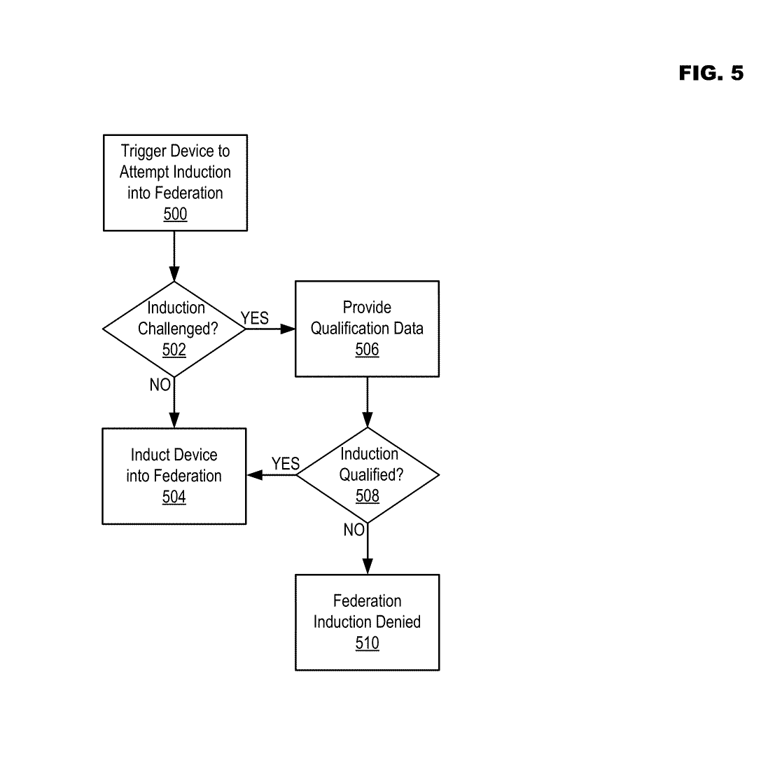

FIG. 5 illustrates example operations for induction into a federation in accordance with at least one embodiment of the present disclosure. In operation 500, a device may be triggered to attempt induction into a federation. Triggering may be caused by a manufacturing operation, user interaction, device sensing, etc. A determination may then be made in operation 502 as to whether induction into the federation is challenged. For example, induction into a federation attempted during device assembly may not be challenged, whereas induction into a federation attempted through user configuration, device touching, network interaction, etc. may require some level of qualification. If it is determined in operation 502 that induction into the federation is not challenged, then the device may be inducted into the federation in operation 504.

If in operation 502 it is determined that induction into the federation is challenged, then in operation 506 qualification data may be provided to support the attempt at induction into the federation. For example, qualification data may comprise personal information about the user, device-related and/or network-related identification data, user biometric data (e.g., fingerprint), etc. A determination may then be made in operation 508 as to whether the attempt at induction has been qualified. If it is determined in operation 508 that the qualification data is sufficient, correct, etc., then in operation 504 the device may be inducted into the federation which may include, for example, including the device on a list of federation devices, altering data on the device and/or placing data on the device allowing it to be associated with the federation, etc. Alternatively, if it is determined in operation 508 that the qualification data is insufficient, incorrect, etc., then in operation 510 the device may be denied induction into the federation.

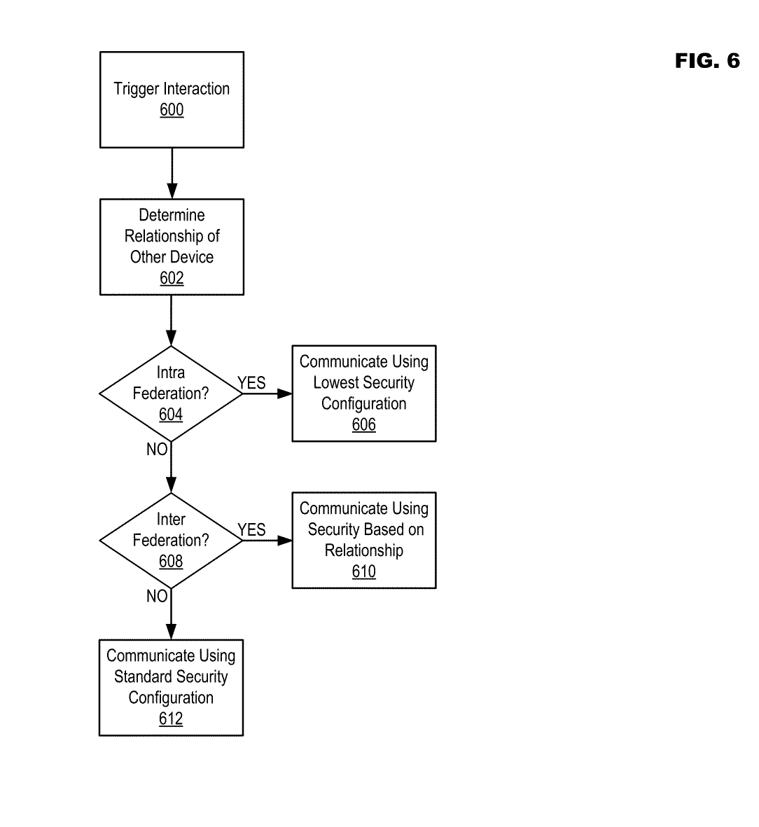

FIG. 6 illustrates example operations for operating in a federation in accordance with at least one embodiment of the present disclosure. In operation 600, interaction may be triggered. For example, a device may have data to transmit to another device, or may receive data from the other device. The relationship between the devices may then be determined in operation 602. For example, it may be determined whether the other device in the same federation as the device, is in another federation familiar to the device, is not in a federation, etc.

A determination may then be made in operation 604 as to whether the interaction will be within the same federation (e.g., intra-federation). If it is determined in operation 604 that the communication is intra-federation, then in operation 606 the communication may proceed using the lowest (e.g., least restrictive) security settings. If in operation 604 it is determined that the interaction will not be intra-federation, then in operation 608 a further determination may be made as to whether the interaction will be inter-federation (e.g., between two federations that have some familiarity with each other). If in operation 608 it is determined that the interaction will be inter-federation, then in operation 610 the communication may proceed using security settings based on the relationship between the federations. If in operation 608 it is determined that the interaction is not inter-federation, then in operation 612 the communication may proceed between the two devices utilizing a standard security configuration including, for example, an amount of security that may be typically associated with a standard communication protocol being employed to support interaction between two devices that are not related in any manner.

While FIGS. 5 and 6 illustrate operations according to different embodiments, it is to be understood that not all of the operations depicted in FIGS. 5 and 6 are necessary for other embodiments. Indeed, it is fully contemplated herein that in other embodiments of the present disclosure, the operations depicted in FIGS. 5 and 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present application is directed to device federation. Interaction between devices in a federation may be conducted using reduced security, while interactions with devices outside the federation may be conducted with a variable security up to a standard level of security that may be associated with a communication protocol. A device may comprise at least a communication module and a federation module. The federation module may include at least a relationship rules module having at least one rule based on relationships between devices and a link security control module to control the amount of security utilized during interaction based on the at least one rule. The link security control module may also control how a device may be inducted into a federation by, if necessary, providing qualification data to qualify the device for induction.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for device federation, as provided below.

According to example 1 there is provided a device to operate in a federation of devices. The device may comprise a communication module to support interaction with other devices and a federation module to identify at least one other device with which interaction is to take place via the communication module, determine a relationship between the device and at least one other device and configure an amount of security to be employed in the interaction with the at least one other device based on the relationship.

Example 2 may include the elements of example 1, wherein the federation module being to identify the at least one other device comprises the federation module being to cause the communication module to transmit a message to the at least one other device, the message requesting at least one of user identification data, device identification data or a federation identification data.

Example 3 may include the elements of example 2, wherein the federation module being to determine a relationship comprises the federation module being to determine if the at least one other device is in a federation with the device, is in another federation familiar to the device or is not in a federation.

Example 4 may include the elements of example 3, wherein the federation module comprises at least a relationship rules module including at least one rule to control the amount of security employed in the interaction with the at least one other device based at least on the relationship and a link security control module.

Example 5 may include the elements of example 3, wherein the federation module comprises at least a relationship rules module and a link security control module.

Example 6 may include the elements of example 5, wherein the relationship module comprises at least one rule to control the amount of security employed in the interaction with the at least one other device based at least on the relationship.

Example 7 may include the elements of example 6, wherein at least one rule controlling when the other device is in a federation with the device, or in another federation familiar to the device, is to cause the device to interact with the at least one other device with reduced security.

Example 8 may include the elements of example 7, wherein the device interacts with the at least one other device via a reduced security/high speed link.

Example 9 may include the elements of example 7, wherein at least one rule controlling with the other device is in another federation familiar to the device is to cause the device to interact with the at least one other device utilizing a level of security higher than if the device and the at least one other device were in the same federation.

Example 10 may include the elements of example 9, wherein the level of security is based on the relationship between the federation and the familiar federation.

Example 11 may include the elements of example 7, wherein the device being to interact with the at least one other device with reduced security comprises the device being to engage in communication with the at least one other device utilizing a standard communication protocol with at least one level of encryption that would typically exist in the standard communication protocol being removed.

Example 12 may include the elements of example 11, wherein at least one rule controlling when the at least one other device is not federated is to cause the device to interact with the at least one other device utilizing the standard communication protocol.

Example 13 may include the elements of any of examples 6 to 12, wherein the link security control module is to configure the amount of security to be employed in the interaction based at least on the at least one rule.

Example 14 may include the elements of any of examples 6 to 13, wherein the link security control module is further to control induction of the device into a federation.

Example 15 may include the elements of example 14, wherein the link security control module being to control induction of the device into a federation comprises the link security control module being to present qualification data to qualify the device for being inducted into the federation.

Example 16 may include the elements of example 15, wherein the qualification data is stored in the device when the device is manufactured.

Example 17 may include the elements of example 15, wherein the qualification data comprises at least one of network data, biometric data or user personal data.

According to example 18 there is provided a method for operating in a federation of devices. The method may comprise identifying, in a device, at least one other device with which interaction is to take place, determining a relationship between the device and the at least one other device and configuring an amount of security to be employed in the interaction with the at least one other device based on the relationship.

Example 19 may include the elements of example 18, wherein identifying the at least one other device comprises transmitting a message to the at least one other device, the message requesting at least one of user identification data, device identification data or a federation identification data.

Example 20 may include the elements of example 19, wherein determining a relationship comprises determining if the at least one other device is in a federation with the device, is in another federation familiar to the device or is not federated.

Example 21 may include the elements of example 20, and may further comprise controlling interaction when the other device is in a federation with the device, or in another federation familiar to the device, by causing the device to interact with the at least one other device with reduced security.

Example 22 may include the elements of example 21, and may further comprise controlling interaction when the other device is in another federation familiar to the device by causing the device to interact with the at least one other device utilizing a level of security higher than if the device and the at least one other device were in the same federation.

Example 23 may include the elements of example 22, wherein the level of security is based on the relationship between the federations.

Example 24 may include the elements of example 21, wherein interacting with the at least one other device with reduced security comprises engaging in communication with the at least one other device utilizing a standard communication protocol with at least one level of encryption that would typically exist in the standard communication protocol being removed.

Example 25 may include the elements of example 24, and may further comprise controlling interaction when the at least one other device is not federated by causing the device to interact with the at least one other device utilizing the standard communication protocol. Example 26 may include the elements of any of examples 18 to 25, and may further comprise presenting qualification data to qualify the device for induction into a federation.

Example 27 may include the elements of example 26, and may further comprise storing the qualification data in the device when the device is manufactured.

Example 28 may include the elements of example 26, wherein the qualification data comprises at least one of network data, biometric data or user personal data.

According to example 29 there is provided a system including at least two devices, the system being arranged to perform the method of any of the above examples 18 to 28.

According to example 30 there is provided a chipset arranged to perform the method of any of the above examples 18 to 28.

According to example 31 there is provided at least one machine readable medium comprising a plurality of instructions that, in response to be being executed on a computing device, cause the computing device to carry out the method according to any of the above examples 18 to 28.

According to example 32 there is provided a device configured to operate in a federation of devices, the device being arranged to perform the method of any of the above examples 18 to 28.

According to example 33 there is provided a system for operating in a federation of devices. The system may comprise means for identifying, in a device, at least one other device with which interaction is to take place, means for determining a relationship between the device and the at least one other device and means for configuring an amount of security to be employed in the interaction with the at least one other device based on the relationship.

Example 34 may include the elements of example 33, wherein the means for identifying the at least one other device comprise means for transmitting a message to the at least one other device, the message requesting at least one of user identification data, device identification data or a federation identification data. Example 35 may include the elements of example 34, wherein the means for determining a relationship comprise means for determining if the at least one other device is in a federation with the device, is in another federation familiar to the device or is not federated.

Example 36 may include the elements of example 35, and may further comprise means for controlling interaction when the other device is in a federation with the device, or in another federation familiar to the device, by causing the device to interact with the at least one other device with reduced security.

Example 37 may include the elements of example 36, wherein the means for interacting with the at least one other device with reduced security comprise means for engaging in communication with the at least one other device utilizing a standard communication protocol with at least one level of encryption that would typically exist in the standard communication protocol being removed.

Example 38 may include the elements of example 37, and may further comprise means for controlling interaction when the at least one other device is not federated by causing the device to interact with the at least one other device utilizing the standard communication protocol.

Example 39 may include the elements of any of examples 33 to 38, and may further comprise means for presenting qualification data to qualify the device for induction into a federation.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device to operate in a federation of devices, comprising:
a communication module to support interaction with other devices; and
a federation module to:
identify at least one other device with which interaction is to take place via the communication module;
determine a relationship between the device and at least one other device; and
configure an amount of security to be employed in the interaction with the at least one other device based on the relationship.

2. The device of claim 1, wherein the federation module being to identify the at least one other device comprises the federation module being to cause the communication module to transmit a message to the at least one other device, the message requesting at least one of user identification data, device identification data or a federation identification data.

3. The device of claim 2, wherein the federation module being to determine a relationship comprises the federation module being to determine if the at least one other device is in a federation with the device, is in another federation familiar to the device or is not in a federation.

4. The device of claim 3, wherein the federation module comprises at least a relationship rules module and a link security control module.

5. The device of claim 4, wherein the relationship module comprises at least one rule to control the amount of security employed in the interaction with the at least one other device based at least on the relationship.

6. The device of claim 5, wherein at least one rule controlling when the other device is in a federation with the device, or in another federation familiar to the device, is to cause the device to interact with the at least one other device with reduced security.

7. The device of claim 6, wherein the device being to interact with the at least one other device with reduced security comprises the device being to engage in communication with the at least one other device utilizing a standard communication protocol with at least one level of encryption that would typically exist in the standard communication protocol being removed.

8. The device of claim 7, wherein at least one rule controlling when the at least one other device is not federated is to cause the device to interact with the at least one other device utilizing the standard communication protocol.

9. The device of claim 5, wherein the link security control module is to configure the amount of security to be employed in the interaction based at least on the at least one rule.

10. The device of claim 5, wherein the link security control module is further to control induction of the device into a federation.

11. The device of claim 10, wherein the link security control module being to control induction of the device into a federation comprises the link security control module being to present qualification data to qualify the device for being inducted into the federation.

12. A method for operating in a federation of devices, comprising:
identifying, in a device, at least one other device with which interaction is to take place;
determining a relationship between the device and the at least one other device; and
configuring an amount of security to be employed in the interaction with the at least one other device based on the relationship.

13. The method of claim 12, wherein identifying the at least one other device comprises transmitting a message to the at least one other device, the message requesting at least one of user identification data, device identification data or a federation identification data.

14. The method of claim 13, wherein determining a relationship comprises determining if the at least one other device is in a federation with the device, is in another federation familiar to the device or is not federated.

15. The method of claim 14, further comprising:
controlling interaction when the other device is in a federation with the device, or in another federation familiar to the device, by causing the device to interact with the at least one other device with reduced security.

16. The method of claim 15, wherein interacting with the at least one other device with reduced security comprises engaging in communication with the at least one other device utilizing a standard communication protocol with at least one level of encryption that would typically exist in the standard communication protocol being removed.

17. The method of claim 16, further comprising:
controlling interaction when the at least one other device is not federated by causing the device to interact with the at least one other device utilizing the standard communication protocol.

18. The method of claim 12, further comprising:
presenting qualification data to qualify the device for induction into a federation.

19. At least one machine-readable storage medium having stored thereon, individually or in combination, instructions that when executed by one or more processors result in the following operations for operating in a federation of devices, comprising:
identifying, in a device, at least one other device with which interaction is to take place;
determining a relationship between the device and the at least one other device; and
configuring an amount of security to be employed in the interaction with the at least one other device based on the relationship.

20. The medium of claim 19, wherein the instructions for identifying the at least one other device comprise instructions for transmitting a message to the at least one other device, the message requesting at least one of user identification data, device identification data or a federation identification data.

21. The medium of claim 20, wherein the instructions for determining a relationship comprise instructions for determining if the at least one other device is in a federation with the device, is in another federation familiar to the device or is not federated.

22. The medium of claim 21, further comprising instructions that when executed by one or more processors result in the following operations comprising:
controlling interaction when the other device is in a federation with the device, or in another federation familiar to the device, by causing the device to interact with the at least one other device with reduced security.

23. The medium of claim 22, wherein the instructions for interacting with the at least one other device with reduced security comprise instructions for engaging in communication with the at least one other device utilizing a standard communication protocol with at least one level of encryption that would typically exist in the standard communication protocol being removed.

24. The medium of claim 23, further comprising instructions that when executed by one or more processors result in the following operations comprising:
controlling interaction when the at least one other device is not federated by causing the device to interact with the at least one other device utilizing the standard communication protocol.

25. The medium of claim 19, further comprising instructions that when executed by one or more processors result in the following operations comprising:
presenting qualification data to qualify the device for induction into a federation.
